(19) United States
(12) Patent Application Publication
(10) Pub. No.: US 2021/0037725 A1
(43) Pub. Date: Feb. 11, 2021

(54) IRRIGATION WATER SUPPLY DEVICE FOR LANDSCAPING

(71) Applicant: Zhijun Wang, Shenzhen (CN)

(72) Inventors: ZHIJUN WANG, Shenzhen (CN); JINMEI ZHANG, Shenzhen (CN)

(21) Appl. No.: 16/654,024

(22) Filed: Oct. 16, 2019

(30) Foreign Application Priority Data
Aug. 9, 2019 (CN) 2019107336529

(51) Int. Cl. A01G 25/00; B05B 15/625; B05B 3/04

(52) U.S. Cl. CPC A01G 25/00; B05B 3/0409; B05B 15/625

(57) ABSTRACT

The present disclosure provides an irrigation water supply device for landscaping, relating to a technical field of landscaping. The irrigation water supply device for landscaping includes supporting parts. A middle mounting plate is disposed on one side of the supporting parts. An installation part is formed by the middle mounting plate and one side of the supporting parts, and a spraying part is disposed on a top of the installation par. A water inlet pipe is disposed on a bottom of the spraying part. The supporting parts include installation frames. First clamping heads are clamped at a bottom of the installation frames, and second clamping heads are clamped at one side of the installation frame. One side of the second clamping heads is fixedly connected with side mounting plates. A top of the side installation plates is fixedly connected with clamping hooks.

### TECHNICAL FIELD

The present disclosure relates to a field of landscaping, in particular to an irrigation water supply device for landscaping.

### BACKGROUND

An irrigation water supply device is a farmland irrigation device which sprays pressurized water flow into air through a spraying head, and is scattered in the field and crops in the form of raindrops. Irrigation water can be pressurized by a water pump, and can also utilize natural falling difference of a high-water-level water source. Spray irrigation equipment, pressurized by the water pump, includes a power machine, the water pump, a water delivery pipeline, and the spraying head, etc. Spray irrigation equipment utilizing the natural falling difference can be used without the power machine and the water pump. However, the present irrigation water supply device further has the following disadvantages:

1. In the prior art, installation and disassembly operation of supporting parts and ground requires too many tools and is tedious in process, so that a combined disassembly effect of the device is not ideal; and

2. In the prior art, when the device is in a state for rotary spray irrigation, an effect of the device only driving by water flow is single. Moreover, torsional damage is easily caused to a water pipe in an operation process performed by users.

### SUMMARY

Aiming at disadvantages in the prior art, the present disclosure provides an irrigation water supply device for landscaping. The irrigation water supply device for landscaping has advantages that supporting parts and an installation part of the device are conveniently disassembled, a combination effect of the device is improved, operation of assembling and disassembling of users is facilitated, and torsion damage is prevented when the users use a water pipe, and so on. A problem that installation and disassembly operation of supporting parts and ground requires too many tools and is tedious in a process, so that a combined disassembly effect of the device is not ideal is solved. Moreover, a problem that when the device is in a state for rotary spray irrigation, an effect of the device only driving by water flow is single, and torsional damage is easily caused to a water pipe in an operation process performed by users is further solved.

In order to achieve objectives of conveniently disassembling a supporting part and an installation part, improving a combined effect of a device, making the device convenient for users to install and disassemble, and preventing a water pipe from torsional damage when the users use the water pipe, the present disclosure provides the irrigation water supply device for landscaping.

1. The irrigation water supply device for landscaping includes installation frames, and first clamping heads and second clamping heads. The first clamping heads and the second clamping heads are screwed to achieve an objective of conveniently disassembling supporting parts and an installation part, so that the combined effect is improved and it is convenient for the users to install and disassemble the device.

2. The irrigation water supply device for landscaping includes a rotary disc, a first magnetic block, a second magnetic block, and a third magnetic block. Due to fact of magnetic repulsion, a driving effect of the device in a rotating process is improved when the rotary disc rotates. The irrigation water supply device for landscaping further includes a pipe sleeve, which is convenient for an upper pipe body and a lower pipe body of a water inlet pipe to rotate and prevents the water pipe from the torsional damage when the users use the water pipe. The irrigation water supply device for landscaping further includes limiting plates and pressing blocks, which improves a sealing effect of the device in a water inlet process.

### BRIEF DESCRIPTION OF DRAWINGS

FIG. 1 is a schematic diagram showing a structure of an irrigation water supply device for landscaping of the present disclosure:

FIG. 2 is a schematic diagram showing an installation part disassembled from the irrigation water supply device for landscaping of the present disclosure;

FIG. 3 is a schematic diagram showing a structure of a pipe sleeve of the irrigation water supply device for landscaping of the present disclosure;

FIG. 4 is a schematic diagram showing a structure of a spraying part of the irrigation water supply device for landscaping of the present disclosure;

FIG. 5 is a schematic diagram showing the installation part disposing on the irrigation water supply device for landscaping of the present disclosure.

### DETAILED DESCRIPTION

Technical solutions in embodiments of the present disclosure are clearly and completely described in following with reference to accompanying drawings in the embodiments of the present disclosure. Obviously, the described embodiments are only a part of the embodiments of the present disclosure rather than all embodiments. Based on the embodiments of the present disclosure, all other embodiments obtained by persons with ordinary skill in this field without creative efforts belong to protection scope of the present disclosure.

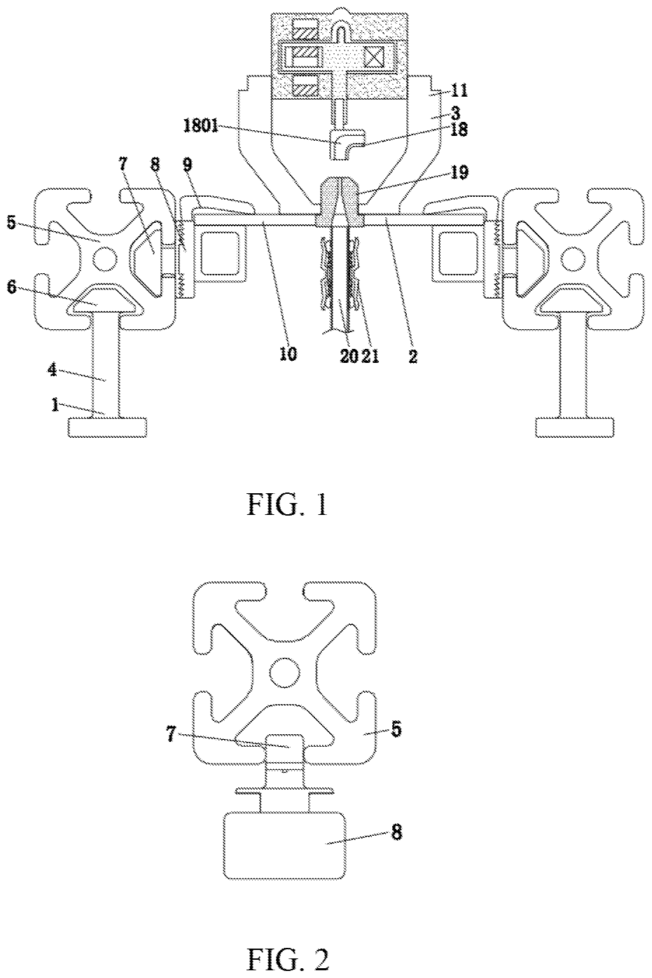

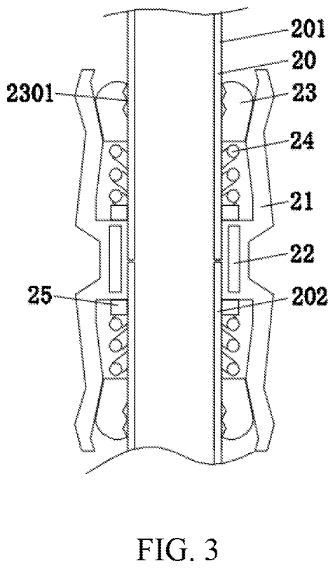

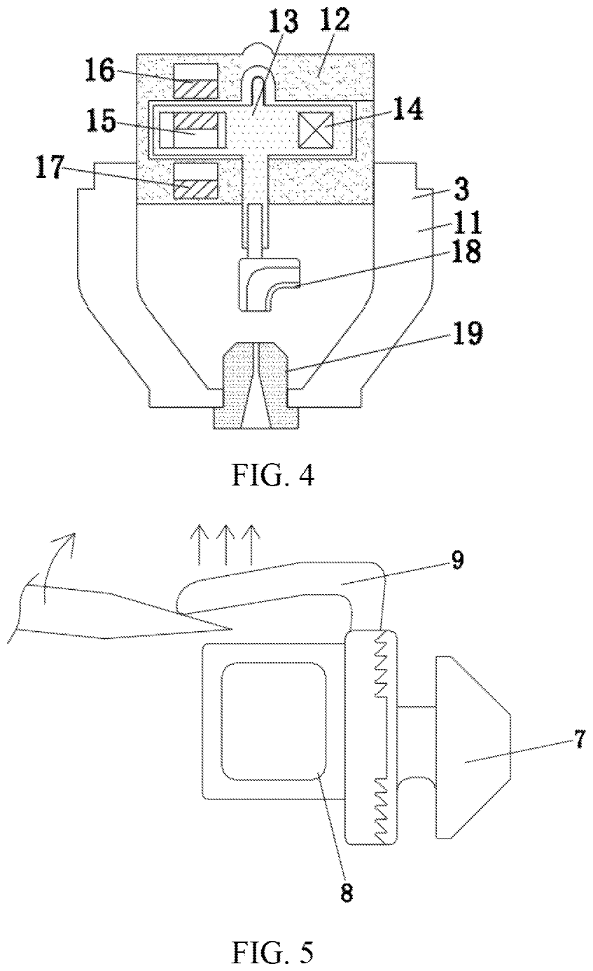

As shown in FIGS. 1-5, the present disclosure provides an irrigation water supply device for landscaping, including supporting parts 1. A middle mounting plate 10 is disposed on one side of the supporting parts 1. An installation part 2 is formed by the middle mounting plate 10 and one side of the supporting parts 1, and a spraying part 3 is disposed on a top of the installation part 2. A water inlet pipe 20 is disposed on a bottom of the spraying part 3.

Furthermore, the supporting parts 1 include installation frames 5. First clamping heads 6 are clamped at a bottom of the installation frames 5, and second clamping heads 7 are clamped at one side of the installation frame 5. One side of the second clamping heads 7 is fixedly connected with side mounting plates 8. A top of the side installation plates 8 is fixedly connected with clamping hooks 9. A bottom of the clamping hooks 9 overlaps with the middle mounting plate 10 located on a top of the side installation plates 8.

Furthermore, the installation part 2 includes a middle installation plate 10, and two sides of a top of the middle installation plate 10 are fixedly connected with installation arms 11.

Furthermore, an installation box 12 is fixedly connected between the installation arms 11. A rotary disc 13 is sleeved in the installation box 12. One side of an interior of the rotary disc 13 is fixedly connected with a balancing weight block 14, and another side of the interior of the rotary disc 13 is fixedly connected with a first magnetic block 15. One side of an interior of the installation box 12 is respectively fixedly connected with a second magnetic block 16 located directly above the first magnetic block 15 and a third magnetic block 17 located directly below the first magnetic block 15. A bottom of the rotary disc 13 is fixedly connected with a rotary accommodating head 18 through a connecting rod, and the rotary accommodating head 18 is located on an inner side of a bending side of the installation arms 11. A bottom of the installation arms 11 is fixedly connected with a spraying head 19, and the spraying head 19 is located at a center of the middle installation plate 10. A bottom of the installation arms 11 is fixedly connected with a spraying head 19, and the spraying head 19 is located at a center of the middle installation plate 10. The water inlet pipe 20 is disposed on a bottom of the spraying head 19.

Furthermore, the water inlet pipe 20 includes an upper pipe body 201 and a lower pipe body 202. The water inlet pipe 20 is sleeved with a pipe sleeve 21. An interior of the pipe sleeve 20 is fixedly connected with limiting plates 22, and the limiting plates 22 are located at two sides of junction of the upper pipe body 201 and the lower pipe body 202. A top and a bottom of an inner wall of the pipe sleeve 21 are fixedly connected with sealing rings 23, and the sealing rings are sleeved with the water inlet pipe 20. An outer ring of the pipe sleeve 21 at two sides of the junction of the upper pipe body 201 and the lower pipe body 202 is sleeved with a hoop ring. Water is input by the water inlet pipe 20, and after the spraying head 19 reaches a spaced spiral channel 1801 of a rotary accommodating head 18, the rotary accommodating head 18 drives the rotary disc 13 to rotate due to action of the spaced threads. A certain driving effect is provided to the device in a rotating process due to an action of magnetic force. Meanwhile, the water is sprayed through one side of the spaced spiral channel 1801. When the supporting parts 1 are required to be disassembled from the device, supporting legs 4 are detached from ground surface, the first clamping heads 6 are rotated to be disassembled, then the installation frames 5 are rotated to disassemble the second clamping heads 7. The two clamping hooks 9 are lifting from two sides of the clamping hooks 9 through sharp pointed objects, and then the installation plate 10 is disassembled.

Specifically, one side of the sealing rings 23 far away from the bottom of the inner wall of the pipe sleeve and one side of the sealing rings 23 far away from the top of the inner wall of the pipe sleeve are fixedly connected with springs 24, ends of the springs 24 are fixedly connected with pressing blocks 25, and the pressing blocks (25) press a top of the limiting blocks 22 and a bottom of the pipe sleeve 21. Frictional screw threads 2301 are disposed on an inner side of the sealing rings 23. A sealing effect of the device is improved through the pressing blocks 25.

Specifically, the spaced spiral channel 1801 is disposed on an interior of the rotary accommodating head 18. A bottom of the spaced spiral channel 1801 is located directly above an outlet of the spraying head 19, which is convenient to accurately butt joint with the spraying part.

Specifically, a top of the first magnetic block 15 is a positive electrode, a bottom of the second magnetic block 16 is a positive electrode, and a top of the third magnetic block is a negative electrode. A certain magnetic force driving effect is improved in the rotating process according to specific repulsion principle.

Specifically, the side installation plates 8 are cuboids. One side of the top of the side installation plates 8 is fixedly connected with the clamping hooks 9, and another side of the top of the side installation plates 8 overlaps with a bottom of the middle installation plate 10, which is convenient to disassemble the supporting parts 1 of the device.

Specifically, front sections of the first clamping heads 6 and the second clamping heads 7 are isosceles trapezoid shapes. Side sections of the first clamping heads 6 and the second clamping heads 7 are plate shapes. Bottoms of the first clamping heads 6 are fixedly connected with the supporting legs 4. The supporting legs 4 are fixedly connected with ground through bolts. It is convenient to dispose the device on the ground surface.

When using, the irrigation water supply device for landscaping includes installation frames 5, the first clamping head 6 and the second clamping head 7 are combined, and the first clamping head 6 and the second clamping head 7 are screwed to achieve an objective of conveniently disassembling a supporting part and an installation part. So that the combined effect is improved and it is convenient for the users to install and disassemble the device. The irrigation water supply device for landscaping includes the rotary disc 13. A first magnetic block 15, the second magnetic block 16, and the third magnetic block 17 are combined, due to fact of magnetic repulsion, a driving effect of the device the in rotating process is conveniently improved when the rotary disc 13 rotates. The irrigation water supply device for landscaping further includes the pipe sleeve 21, which is convenient for an upper pipe body 201 and a lower pipe body 202 of a water inlet pipe 20 to rotate and prevents the water pipe from the torsional damage when the users use the water pipe. The irrigation water supply device for landscaping further includes limiting plates 22 and pressing blocks 25, which improves a sealing effect of the device in a water inlet process.

In conclusion, the present disclosure provides the irrigation water supply device for landscaping. The water is input by the water inlet pipe 20, and after the spraying head 19 reaches the spaced spiral channel 1801 of the rotary accommodating head 18, the rotary accommodating head 18 drives the rotary disc 13 to rotate due to the action of the spaced threads. The certain driving effect is provided to the device in the rotating process due to the action of magnetic force. Meanwhile, the water is sprayed through one side of the spaced spiral channel 1801. When the supporting parts 1 are required to be disassembled from the device, the supporting legs 4 are detached from the ground surface, the first clamping heads 6 are rotated to be disassembled, and then the installation frames 5 are rotated to disassemble the second clamping heads 7. The two clamping hooks 9 are lifting from the two sides of the clamping hooks through the sham objects, and then the installation plate 10 is disassembled.

It should be noted that, in the present disclosure, relational tens such as first and second are only used to distinguish one entity or operation from another entity or operation, and any actual relationship or sequence exists between the entities or the operations does not need to be required or implied. Moreover, the terms “including”, “comprising”, or other variants thereof are intended to encompass a non-exclusive inclusion. So that processes, methods, objects, or other equipment including a series of elements are not only include those elements, but also include other elements not explicitly listed, or further include elements inherent to the processes, the methods, the objects, or the equipment. Without more limitation, elements defined by “including . . . ” do not exclude other identical elements, existing in the above processes, methods, objects, or equipment.

Although the embodiments of the present disclosure have been shown and described, for the persons with ordinary skill in this field, it should be understood that the embodiments can be changed, modified, replaced, and mutated without departing from principles and spirit of the present disclosure. The scope of the present disclosure is defined by the appended claims and equivalents thereof.

What is claimed is:

1. An irrigation water supply for landscaping, comprising: supporting parts; wherein a middle mounting plate is disposed on one side of the supporting parts; an installation part is formed by the middle mounting plate and one side of the supporting parts, and a spraying part is disposed on a top of the installation part; a water inlet pipe is disposed on a bottom of the spraying part;
wherein the supporting parts comprise installation frames; first clamping heads are clamped at a bottom of the installation frames, and second clamping heads are clamped at one side of the installation frame; one side of the second clamping heads is fixedly connected with side mounting plates; a top of the side installation plates is fixedly connected with clamping hooks; a bottom of the clamping hooks overlaps with the middle mounting plate located on a top of the side installation plates;
wherein the installation part comprises a middle installation plate, and two sides of a top of the middle installation plate are fixedly connected with installation arms;
wherein an installation box is fixedly connected between the installation arms; a rotary disc is sleeved in the installation box; one side of an interior of the rotary disc (13) is fixedly connected with a balancing weight block (14), and another side of the interior of the rotary disc is fixedly connected with a first magnetic block; one side of an interior of the installation box is respectively fixedly connected with a second magnetic block located directly above the first magnetic block and a third magnetic block located directly below the first magnetic block; a bottom of the rotary disc is fixedly connected with a rotary accommodating head through a connecting rod, and the rotary accommodating head is located on an inner side of a bending side of the installation arms; a bottom of the installation arms is fixedly connected with a spraying head, and the spraying head is located at a center of the middle installation plate; a bottom of the installation arms is fixedly connected with a spraying head, and the spraying head is located at a center of the middle installation plate; the water inlet pipe is disposed on a bottom of the spraying head;
wherein the water inlet pipe comprises an upper pipe body and a lower pipe body; the water inlet pipe is sleeved with a pipe sleeve; an interior of the pipe sleeve is fixedly connected with limiting plates, and the limiting plates are located at two sides of junction of the upper pipe body and the lower pipe body; a top and a bottom of an inner wall of the pipe sleeve are fixedly connected with sealing rings, and the sealing rings are sleeved with the water inlet pipe; an outer ring of the pipe sleeve at two sides of the junction of the upper pipe body and the lower pipe body is sleeved with a hoop ring.

2. The irrigation water supply for landscaping according to claim 1, wherein one side of the sealing rings far away from the bottom of the inner wall of the pipe sleeve and one side of the sealing rings far away from the top of the inner wall of the pipe sleeve are fixedly connected with springs, ends of the springs are fixedly connected with pressing blocks, and the pressing blocks press a top of the limiting blocks and a bottom of the pipe sleeve.

3. The irrigation water supply for landscaping according to claim 1, wherein frictional screw threads are disposed on an inner side of the sealing rings.

4. The irrigation water supply for landscaping according to claim 1, wherein a spaced spiral channel is disposed on an interior of the rotary accommodating head; a bottom of the spaced spiral channel is located directly above an outlet of the spraying head.

5. The irrigation water supply for landscaping according to claim 1, wherein a top of the first magnetic block is a positive electrode; a bottom of the second magnetic block is a positive electrode; and a top of the third magnetic block is a negative electrode.

6. The irrigation water supply for landscaping according to claim 1, wherein the side installation plates are cuboids; one side of the top of the side installation plates is fixedly connected with the clamping hooks, and another side of the top of the side installation plates overlaps with a bottom of the middle installation plate.

7. The irrigation water supply for landscaping according to claim 1, wherein front sections of the first clamping heads and the second clamping heads are isosceles trapezoid shapes; side sections of the first clamping heads and the second clamping heads are plate shapes; bottoms of the first clamping heads are fixedly connected with supporting legs; the supporting legs are fixedly connected with ground through bolts.
